(19) United States
(12) Patent Application Publication
(10) Pub. No.: US 2014/0006913 A1
(43) Pub. Date: Jan. 2, 2014

(54) VISUAL TEMPLATE EXTRACTION

(71) Applicants: Ramesh Gopalakrishna, Bangalore (IN); Anand S. Edwin, Bangalore (IN)

(72) Inventors: Ramesh Gopalakrishna, Bangalore (IN); Anand S. Edwin, Bangalore (IN)

(73) Assignee: Adobe Systems Incorporated, San Jose, CA (US)

(21) Appl. No.: 11/962,794

(22) Filed: Dec. 21, 2007

(51) Int. Cl. G06F 3/14; G06F 17/30

(52) U.S. Cl. 715/200; 707/E17.116

(57) ABSTRACT

Systems and methods are provided for authoring a web page template. A software code authoring tool is provided that enables authoring of source code that defines a Web site template. An improved template design and content management solution is provided that enables a user-friendly way for an author to create a web page template from a pre-existing output presentation. For instance, an authoring tool enables the author to designate what regions in a pre-existing web page are to be editable in a template created from the web page, wherein the editable regions of the template may be edited by a user interacting with an authoring tool.

### TECHNICAL FIELD

The following description relates to software development, and more specifically to systems and methods for extracting templates for use in web page development.

### BACKGROUND

With the explosion of the Internet and the World Wide Web, there has been an increasing demand for Web development tools. Web development or design (the terms “development” and “design” are used interchangeably herein, as are “developer” and “designer”) involves creating a Web site, which is a collection of web pages that are hosted on one or more servers and are accessible by the Internet, portable communication devices, and other communication means. The first Web sites were made up of straightforward web pages that contained nothing more than text and hyperlinks to other web pages. Web pages were, and typically still are, written in a markup language such as hypertext markup language (HTML) and displayable by an application called a browser. Initially, the limited functionality and simplicity of HTML allowed nearly any user to create a simple web page. As the Internet proliferated, however, the complexity of web pages and the underlying source code increased. Web developers began to incorporate images, tables, and other forms of media into web pages. With each added function, the complexity of the source code defining web pages increased. As the complexity of source code defining web pages increased, a need for web page development tools arose.

In response to the increasing demand for web developers and tools for designing web pages, companies like Macromedia and Microsoft developed web page editors that allow users who have a limited knowledge of HTML to create web pages. DREAMWEAVER®, available from Adobe Systems Incorporated, is one example of a software authoring tool that allows web developers to design HTML web pages with a limited knowledge of HTML. DREAMWEAVER also allows the developer to design in other markup languages, such as Extensible Markup Language (XML), Extensible HTML (XHTML), Active Server Page (ASP), COLDFUSION™ Markup Language (CFML™). DREAMWEAVER allows a developer to create a document in an environment that includes both a text-based code view and a graphical-based design view. DREAMWEAVER's graphical-based design view is a What You See Is What You Get (WYSIWYG) view of the document that allows users to visually manipulate the interpreted and graphically laid-out version of a document, such as, for example, by dragging, dropping, cutting, and pasting visual components.

WYSIWIG development tools like DREAMWEAVER make web development more accessible, but the cost of creating and maintaining a website can still be prohibitive. In addition to the costs associated with developing a website, any time a web page must be updated, or content added, changes to the underlying source code must be made. Traditionally, to make changes to web page content, a designer's customer submits the revised content to the designer, and the designer modifies the underlying source code of the web page such that its output presentation presents the revised content desired by the customer. Often, the designer agrees to a maintenance contract with the customer, wherein the designer agrees to accept content changes from the customer and modify the customer's web page source code to modify the web page's output presentation to reflect the desired content changes. The customer may then e-mail the designer a list of desired changes, and the designer then downloads (from the hosting web server) the web pages to be modified to the designer's computer and use an authoring tool like DREAMWEAVER to modify the source code to make the content changes. The designer then pushes the modified source pages back up to the web server and notifies the customer that the changes have been made. In this scenario, the designer remains integral to maintaining the customer's web page.

Such web page “maintenance” tasks as updating the content of the customer's web page, while typically relatively simple to code, often become undesirable. In some instances, the designer may be required to spend an inordinate amount of time performing maintenance on the customer's web pages for updating content, thus taking time away from other tasks such as attracting new customers, designing new web pages (e.g., for new customers), etc. Additionally, the designer may present a bottleneck to updating of a customer's web page content. That is, the customer may have to wait an undesirably long time for the designer to update the page source code to implement the desired content changes.

In an effort to reduce the costs associated with maintenance of web sites, a number of client-side desktop applications that enable the customer to modify content of the customer's web page have been developed. One such application is CONTRIBUTE®, available from Adobe Systems Incorporated. In general, CONTRIBUTE is a software application for editing the content of a website that allows a wide variety of people within an organization to update web pages by reducing the amount of web design skill necessary for the process. CONTRIBUTE enables non-programmers to modify content of a web page, as it employs an intuitive WYSIWYG development environment, which allows those with little or no programming experience to update web page content. CONTRIBUTE allows users to update a website using a word processor and eliminates the need for recurring web design costs and updates.

Even client-side development applications like CONTRIBUTE, however, can be cost prohibitive. Many client-side development applications, including CONTRIBUTE, allow users to work from a web page template to author a web page. In general, as is well known in the art, a template is a reusable object that allows a user to rapidly generate and produce web pages through use of a pre-defined layout. Templates are provided for various software applications, such as word processor applications that provide templates for certain types of document layouts such as letters, resumes, and recipes; spreadsheet applications that provide templates for types of document layouts such as financial budgets, to do lists, and contacts; and presentation applications that provide templates for various presentation layouts. In each instance, a user may select a template that provides the desired layout and format characteristics of the document to be authored, and the user may then populate various fields of the template with content to produce a resulting document. The underlying template is not modified, and can be reused to generate any number of documents with the same look and feel.

In the context of web page design, templates provide a starting point from which an a user may author any number of web pages that may contain different content specified by the author, but which have a consistent look and feel as defined by the template from which they originated. Users of client-side applications that make use of templates are required to hire a developer or invest in technology to create and update web page templates. Once a template has been created, users of the client-side application may update web page content. Typically, the user cannot edit “look and feel” elements of the template. Rather, templates include predefined regions that allow users to edit content. For example, author specific content to be included at various regions of the page.

As noted above, users of client-side development tools like CONTRIBUTE are reliant on developers to create the web page templates from which they work. Often, the costs associated with hiring a designer to create a web page template cannot be justified. Thus, there exists a need for a web development tool that allows novice users and for designers to efficiently and affordably create templates from which web pages can be authored.

### BRIEF SUMMARY

The present invention is directed generally to systems and methods that allow users to create templates for use in web page authoring. According to certain embodiments, a template authoring tool is provided that enables creation of template source code that defines editable regions within the output presentation of the template. Embodiments of the present invention provide an improved template creation solution that enables a user-friendly way for a user to create a web page template from a pre-existing output presentation. For instance, according to certain embodiments of the present invention, a template authoring tool is provided that enables a template to be authored from an existing web page. In one embodiment, the authoring tool enables a user to designate portions of a web page that are to be extracted to form a template. And in one embodiment, the authoring tool further enables the user to designate what regions in the extracted portion of the web page are to be editable in the template.

Further, in certain embodiments, the template authoring tool enables the template author to designate, in the template page source code, a level of edit capability that is afforded to the authorized user for a designated editable region of the template page. That is, the designer may designate which of a plurality of editing functions, such as edit formatting capabilities, the authorized user is to be afforded when editing a given portion of the web page. For instance, the template author may designate that in a first region of the template page the authorized user is permitted to edit the text, but is unable to perform formatting edits, whereas the designer may designate that in a second region of the web page the authorized user is permitted to edit the text as well as perform certain formatting edits.

Further still, in certain embodiments, the template authoring tool captures the attributes of regions designated as editable by the template author and enables the template author to designate, in the web template source code, that these attributes may not be altered by the authorized user. That is, the template authoring tool captures the formatting, and the authorized user is only able to edit the content of the region. For instance, the template author may design a first region of the template page the authorized user is permitted to edit. The authoring tool captures the formatting of the selected region and any textual, or content, edits the authorized user makes conform with the formatting attributes captured by the template authoring tool.

The template authoring tool disclosed herein may be incorporated into a number of products. For example, in certain embodiments, the template authoring tool may be included in a web page authoring tool such as DREAMWEAVER or CONTRIBUTE. In other embodiments, the template authoring tool may be a separate application.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1A-B show an exemplary system illustrating a common web page authoring and deployment technique of the prior art;

FIG. 2 shows a block diagram of an exemplary system according to one embodiment of the present invention;

FIGS. 3A-3C show a an exemplary scenario of an authorized user performing template authoring according to an embodiment of the present invention;

FIG. 4 shows an exemplary operational flow diagram for a template authoring tool according to one embodiment of the present invention;

FIG. 5 shows an exemplary operational flow diagram for authoring a template according to one embodiment of the present invention;

FIG. 6 shows an exemplary system on which embodiments of the present invention may be implemented.

### DETAILED DESCRIPTION

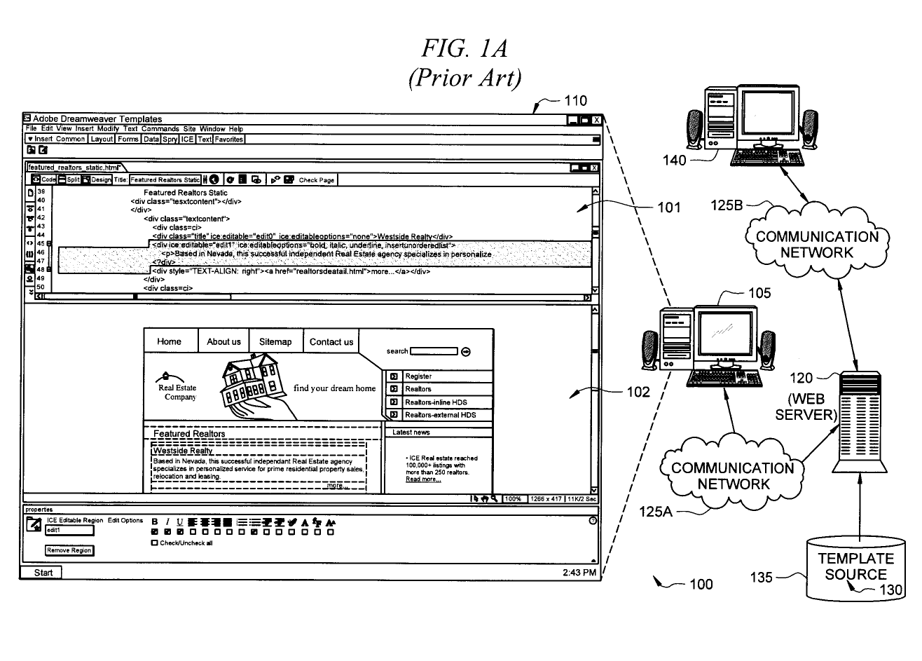

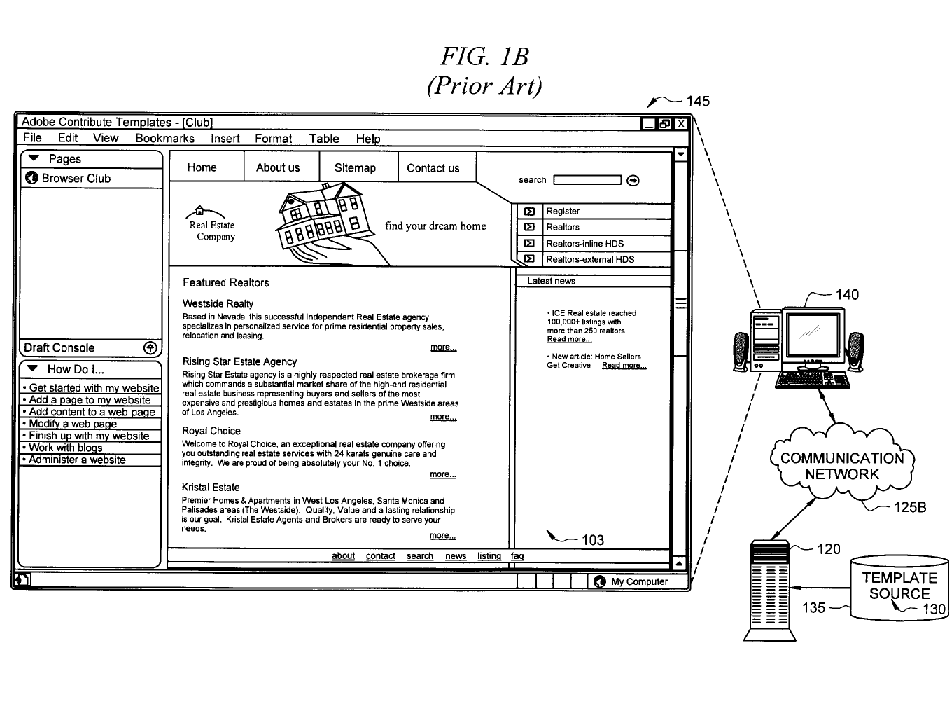

Turning to FIGS. 1A-1B, an exemplary system 100 illustrating a common web page authoring and deployment technique of the prior art is shown. As shown, system 100 comprises a first processor-based computer 105, such as a personal computer (PC), laptop computer, server computer, or workstation computer. In this example, a web authoring tool 110 is executing on computer 105. Authoring tool 110 comprises computer-executable software code stored to a computer-readable medium that is readable by a processor of computer 105 and, when executed by such processor, causes computer 105 to perform the various operations described herein for such authoring tool 110. Examples of such a web authoring tool 110 include DREAMWEAVER®, available from Adobe Systems Incorporated, and FRONTPAGE®, available from Microsoft Corporation.

Authoring tool 110 may enable development of software code for web pages (e.g., as is commonly coded using such authoring tools as those included in DREAMWEAVER and FRONTPAGE mentioned above). In many cases, such authoring tool 110 enables an author (e.g., website designer) to create textual source code that defines a graphical presentation format to be generated by an outputting application (e.g., a web page output by a browser, etc.). Thus, a designer may interact with authoring tool 110 (via computer 105) to develop a web page for a customer, as discussed further below.

In this example, authoring tool 110 is operable to present one or more user interfaces with which a user (e.g., designer) may interact to author a document, such as a source code document (or “page source code”) that defines a web page to be generated when read/interpreted by a browser. In this example, authoring tool 110 presents a code view interface 101 and a design view (or “display view”) interface 102. Authoring tool 110 may employ technology similar to that employed by browsers to read a code document (e.g., of code view 101) and display in design view 102 the corresponding page that is generated from such code. Accordingly, such design view 102 may provide developers the ability to view and edit a web page in a visual mode in which the underlying source code (e.g., HTML code, XML code, CSS code, etc.) has been rendered, as if on a web browser. While the developer works on the rendered objects, the authoring tool 110 may translate and effect those changes in the underlying textual code document. Thus, design view 102 provides a design-time view of the output presentation of a web page being authored, which mimics a run-time view of the output presentation that would be presented for such web page by a browser. Such a design view 102 is a known interface that is available in certain authoring tools, such as in DREAMWEAVER®.

In contrast, code view 101 provides a simple text editor in which the actual textual source code (e.g., HTML code, XML code, CSS code, etc.) defining a page to be generated is displayed to the user. Thus, code view 101 shows the textual code that defines the page to be generated when such code is read/interpreted (e.g., by a browser), while design view 102 shows the resulting generated page that is rendered when the underlying code is read/interpreted (e.g., by a browser).

Using authoring tool 110, a designer may create source code for a web page template. Creating of a web page template source code using authoring tool 110 is similar to creating a web page using authoring tool 110. However, when creating a template, code is inserted into the template code that identifies editable regions of the template. Once a designer creates source code for a template via authoring tool 110, the source code is typically stored to a hosting web server 120. For instance, the source code for a web page template may be pushed from computer 105 to web server 120 via a communication network 125A, such as a local area network, the Internet or other wide area network. Alternatively, the source code may otherwise be loaded onto web server 120, and/or computer 105 and web server 120 may be one in the same. The source code 130 for the web page template is stored to data storage 135 of web server 120. Data storage 135 may comprise a hard disk and/or other computer-readable data storage medium that is operable for storing data.

Web server 120 is accessible by clients, such as client computer 140, via a communication network 125B. As shown further in FIG. 1B, a client, such as client computer 140, may access web server 120 and download the template source code 130, which an authoring tool 145 executing on the client computer 140 interprets to generate a corresponding output presentation 103. Using authoring tool 145, a user may edit the content in identified regions of the template and create a web page. Thus, a designer may create a template's source code 130 via authoring tool 110 for a customer, which when deployed on web sever 120 enables clients 140 to access the template page, thus enabling such clients 140 to view a template output presentation 103 of the page and edit selected regions of the template to create a web page using authoring tool 145.

As discussed above, certain projects may not justify the investment required to create a template from scratch. Embodiments of the present invention provide an improved template authoring solution that enables a user-friendly way for template authors to create web page templates. Embodiments of the present invention allow template authors to capture the look and feel of existing output presentations, such as a web site. For instance, according to certain embodiments, a template authoring tool enables the template author to designate, in an existing web page's source code, certain portions of the page where authorized users may later add content. As discussed further herein, the designated portions of the page are formed into an editable region of a template, which may be edited by an authorized user by interacting with an authoring tool, such as that presented by a authoring tool 145 (FIG. 1B).

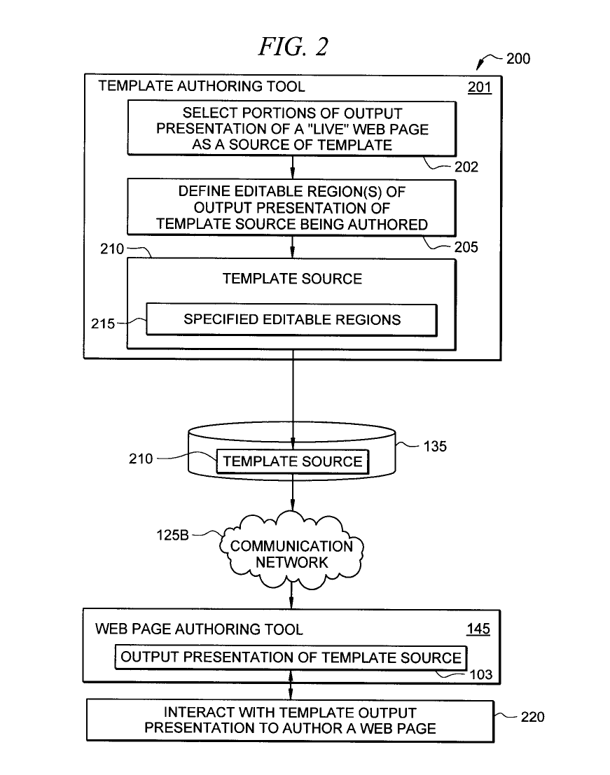

Turning now to FIG. 2, a block diagram of an exemplary system 200 according to one embodiment of the present invention is shown. As shown, system 200 includes a software code authoring tool 201, such as CONTRIBUTE, which is executing on a processor-based device, such as computer 105 of FIG. 1. As with authoring tool 110 of FIG. 1A, authoring tool 201 comprises computer-executable software code stored to a computer-readable medium that is readable by a processor of a computer, such as computer 105, and when executed by such processor, causes the computer to perform the various operations described further herein for such authoring tool 201. As with the example of FIG. 1, authoring tool 201 may enable development of software code for web pages. In many cases, such authoring tool 201 enables an author to create textual code that defines a graphical output presentation format to be generated by an outputting application, such as a web page output by a browser.

As with the above example of FIG. 1, authoring tool 201 is operable to present a graphical interface, with which a user may interact to author a template, such as a template that allows a user of an authoring tool (e.g., authoring tool 145 of FIG. 1B) to define a web page. According to this exemplary embodiment, a user interacts with authoring tool 201 to author template source code 210. As with authoring tool 110 of FIG. 1, authoring tool 201 presents a design view interface 102 with which a designer may interact to author template source code 210 According to this exemplary embodiment, authoring tool 201, in operational block 202, enables a user to select a portion of an output presentation (e.g., a “live” web page) as a source of a template. In this embodiment, the out put presentation source code corresponding to the selected portion of the output presentation is used as a starting point for template authoring. According to this exemplary embodiment, authoring tool 201 enables a user to, in operational block 205, define editable regions of selected portions of the output presentation of the template source code being authored. In this embodiment, editable regions within the template are defined as marker(s) 215 within the template source code 210. For instance, authoring tool 201 enables the user to designate in the template source code 210 (via marker(s) 215) certain regions of the page that may be edited by an authorized user. The markers in this exemplary embodiment are readable by an authoring tool and include unique identifiers associated with the selected region.

In addition to defining editable regions within the template, this exemplary embodiment of authoring tool 201 identifies and extracts the formatting of the selected region. The template authoring tool, in this exemplary embodiment, extracts the formatting of selected regions as cascading style sheets and limits the formatting of editable regions to the formatting identified. In other embodiments, the exemplary template authoring tool allows the user to alter or define the formatting of selected regions. The template authoring tool 201 will visually show the extracted, or styles, for the marked regions as style info (e.g., color, font, justification, etc.) and the user can change modify the regions formatting. The formats are stored for the tag enclosing the region markup so that the region follows this formatting.

The template source code 210 may be stored to data storage 135, whereby the template source code 202 is accessible authorized. Data storage may be local storage (e.g., memory on computer 105) or storage on a web server accessible by authorized users (e.g., web server 120). For instance, as with FIG. 1B, a client, such as client computer 140, may access web server data storage 135 and download template source 210, which an authoring tool 145 executing on the client computer 140 interprets to generate a corresponding template editing interface 103. An authorized user of the template editing interface 103 may, in operational block 220, interact with the template editing interface 103 to define an output presentation page, such as a web page, according to the definition of editable regions 215. That is, the authorized user may edit the content of the output presentation displayed in template editing interface 103, as described further herein, by performing permitted editing operations as defined in the definition of editable region 215.

As with the example of FIG. 1, the template source code 210 may be stored to data storage 135 of server 120, whereby the template source code 210 is accessible to authorized users (e.g., client 140 of FIG. 1) via communication network 125B. For instance, as shown in FIG. 1, a client, such as client computer 140, may access web server 120 and download the template source code 210, which a client authoring tool executing on the client computer 140 interprets to generate a corresponding output presentation 103. According to this exemplary embodiment of the present invention, an authorized user of the authoring tool 201 may, in operational block 220, interact with the template output presentation 103 to author a web page according. That is, the authorized user may edit the content of the output presentation 103, as described further herein, by editing predefined regions as defined in the definition of editable regions 215.

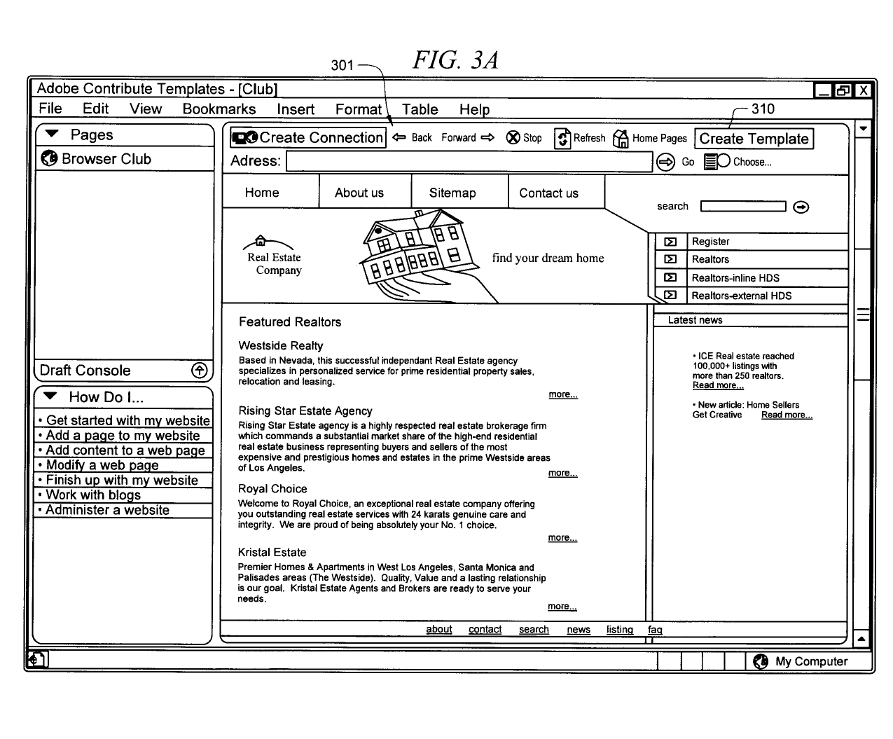

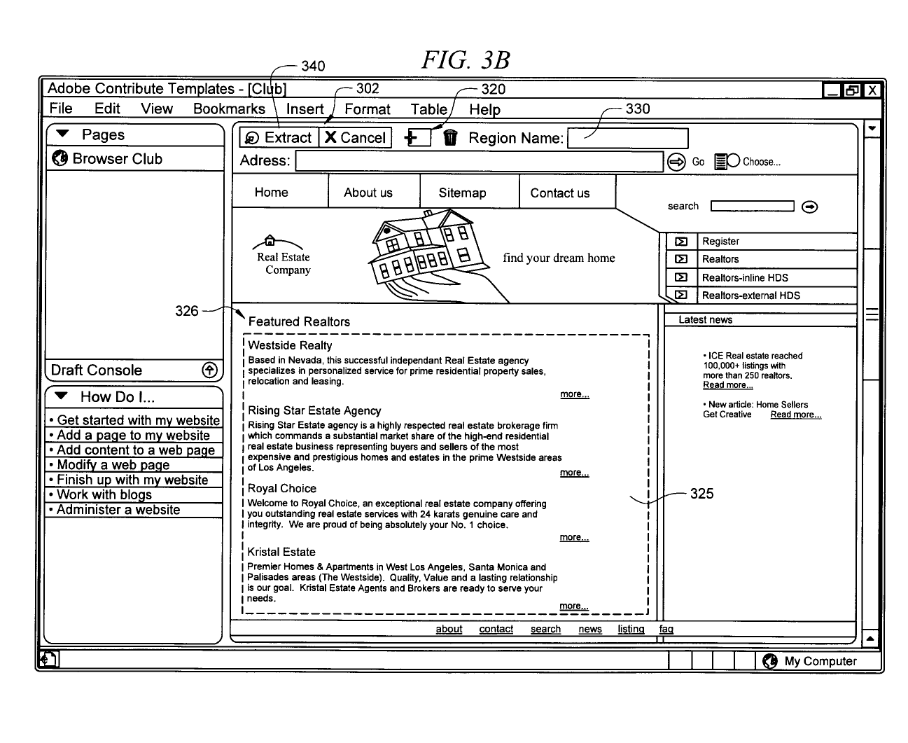

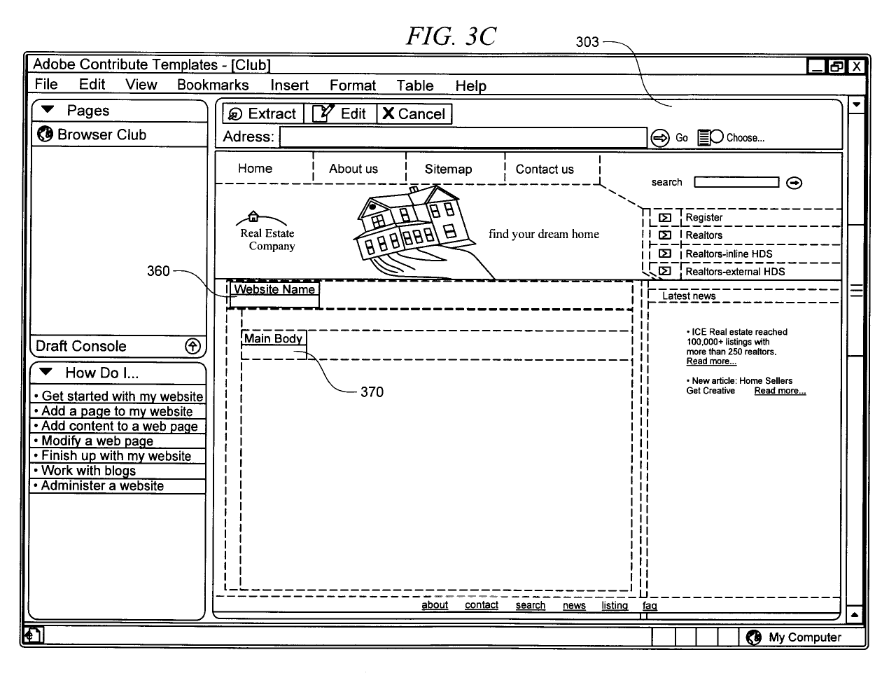

Turning to FIGS. 3A-3C, an exemplary scenario of using exemplary template authoring tool 201 according to an embodiment of the present invention for authoring a web template is shown. FIGS. 3A-3C show an exemplary template authoring tool 201, which comprises computer-executable software code stored to a computer-readable medium that is readable by a processor of a computer 105 to perform the various operations described further herein for such template authoring tool 201. Template authoring tool 201 presents a user interface with which a designer may interact to author a template. That is, a designer may interact with template authoring tool 201 (via computer 105) to develop a template. In this example, template authoring tool 201 is operable to present a user interface with which a user (e.g., developer) may interact to author a document, such as source code document that defines a template to be generated when read/interpreted by an authoring tool.

Referring to FIG. 3A, a user of template authoring tool 201, using navigation view 301, navigates to an output presentation (e.g., an existing “live” web page) that contains at least a portion of the look and feel of a web page the author desires to capture. The output presentation can be any output presentation (i.e., an existing web page, etc.). Once the user of template authoring tool 201 has navigated to an output presentation from which the user intends to create a template, the user selects Create Template button 310. Responsive to the author selecting the Create Template button 310, template authoring tool 201 initiates template extraction view 302, shown in FIG. 3B.

In the example of FIG. 3B, responsive to the user clicking the Markup Editable Region button 320, a user may interact with the output presentation of the “live” web page in template design view 302 to select a region of the web page for which the user desires to define permitted template edit capability. That is, the user may select a region of the “live” web page which the user desires to make editable by an authorized user via interaction with the template authoring tool 201. In the illustrated example of FIG. 3B, the designer has selected a portion 325 of the web page (as shown in the template design view 302). The designer may interact with the template authoring tool 201 to perform such selection of the portion by employing known techniques, such as by clicking a mouse and dragging the mouse to highlight a desired region to be selected. In this example, the region of the page that the designer selects for defining an editable region corresponds to a an element that contains main body text, region 325. Of course, any other region of a web page may be likewise selected.

Still referring to FIG. 3B, after the author defines a region within the output presentation (in FIG. 3B, a web page) as editable, template authoring tool 201 prompts the author to name the region by entering a region name in the Region Name Field 330. Continuing with this exemplary scenario, the user may select as many regions of the output presentation for which the user desires to define template editable regions as desired. For example, the user might elect to make region 326 of the output presentation editable. After the author has defined all editable regions within the base document, the author may finalize the template by selecting the Extract button 340.

Upon the user selecting Extract button 340, template authoring tool 201 creates a template by removing any content from identified regions, and the corresponding elements of source code, and inserting tags into the output presentation source code. These tags identify certain regions as editable and associate a region identifier with each region. Template authoring tool 201 recognizes template markup tags in the template source code and the template is displayed in template editing view 303, as shown in FIG. 3C. Template view 303 identifies the editable regions in the template. For instance, template authoring tool 201 updates template editing view 303 to show editable regions 360 and 370 of the template. As shown, a unique identifier is assigned to each editable region. In this example, regions 360 and 370 include identifiers “Website Name” and “Main Body,” respectively.

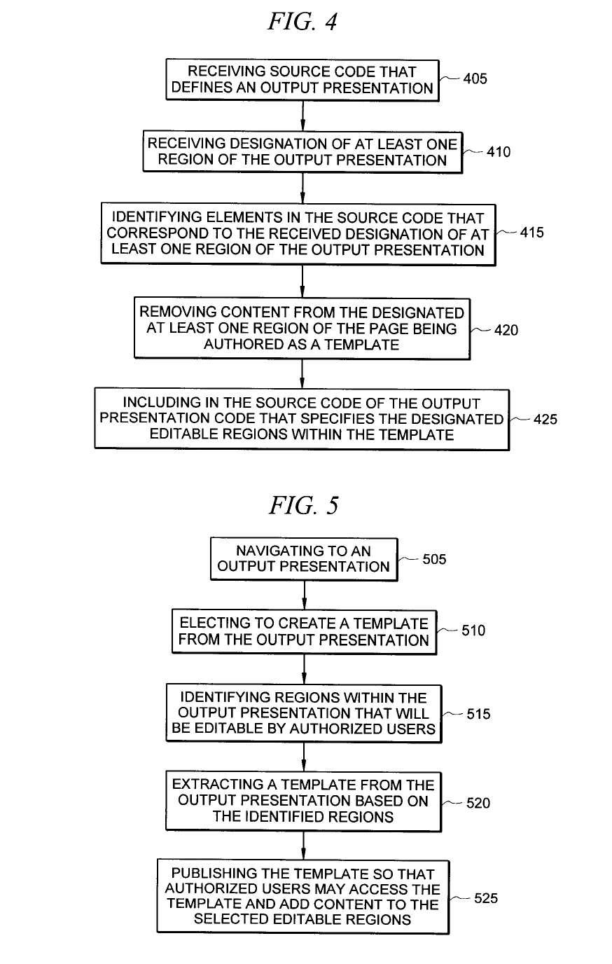

FIG. 4 shows an exemplary operational flow diagram for a template authoring tool according to one embodiment of the present invention. In operational block 405, the template authoring tool receives designation of a source file containing source code for an output presentation from which a template will be authored. For instance, in the above example of FIG. 3A, the template authoring tool receives the source code of the output presentation page from which a web page template is being authored. The source file is displayed as an output presentation within navigation view 301 of the template authoring tool.

At operational block 407, the template authoring tool creates a preliminary template source code based on the source file received by the template authoring tool. In one embodiment of the template authoring tool, the template authoring tool creates a document object model for the output presentation source code received by the template authoring tool.

In operational block 410, the template authoring tool receives designations of regions within the output presentation that will be editable by authorized users. In one embodiment of the template authoring tool, a user of the template authoring tool interacts with the user interface of template authoring tool to perform such designation of the region by employing known techniques, such as by clicking a mouse and dragging the mouse to highlight a desired region to be selected. Or, for instance, in the above example of FIG. 3B, the template authoring tool receives an instruction that output presentation region 325 will be editable.

At operational block 415, the template authoring tool identifies the elements in the output presentation source code that correspond to the regions designated in the output presentation. In one embodiment of the template authoring tool, this is done using the document object model (DOM) structure of the underlying output presentation, which is available while the markup is being made. The template authoring tool identifies the nodes and elements in the DOM that correspond to the region designated in the output presentation and inserts markers for reference by the template authoring tool.

After the exemplary template authoring tool has identified the elements in the output presentation source code that correspond to the identified region the template authoring tool, at operational block 440, removes content from the designated region. All content (e.g., text, images, etc.) inside the identified region is removed. The template authoring tool does not remove formatting elements.

At operational block 425, the template authoring tool inserts markers into the output presentation source code that defines editable regions. In the exemplary embodiment, these markers can be read by the template authoring tool, as well as any compatible client-side development tool that utilizes templates authored by the authoring tool. For example, if the template authoring tool was incorporated into CONTRIBUTE, the markers would be readable by CONTRIBUTE. Markers contain region begin, region end, and attribute to indicate whether it is editable or not etc. Markers such as these are known in the art and found in programs such as DREAMWEAVER and CONTRIBUTE.

Turning now to FIG. 5, an exemplary operational flow diagram for authoring a template according to one embodiment of the present invention is shown. At operational block 505, the template author navigates to an output presentation. Typically, this output presentation will contain elements that embody the look and feel of the template that the author hopes to capture. For instance, the template author might navigate to a particular web site that embodies the look and feel of a web site template the author will create. In the system disclosed by FIGS. 3A-3C, the author would navigate to an output presentation using navigation view 301 of template authoring tool 201.

After navigating to an output presentation page, the template author may elect to create a template from the output presentation. At operational block 510, the user elects to create a template from the output presentation page. For instance, in the above example of FIG. 3A, the template author using template authoring tool 201 selects Extract Template button 310. Upon electing to create a template from the output presentation page, with reference to FIG. 3B, template authoring tool 201 proceeds to template design view 302.

At operational block 515, the exemplary template author identifies regions within the output presentation page that will correspond to editable regions in the template. The user may interact with the user interface of template authoring tool 201 to identify such region by employing known techniques, such as by clicking a mouse and dragging the mouse to highlight a desired region to be selected. In the example of FIG. 3B, the template author identified regions 325 and 326.

After the template author identifies editable regions, the template author extracts a template from the output presentation at operational block 520. In the exemplary embodiment of FIG. 3B, the template author extracts a template by selecting the Extract button 340. Upon selection of the Extract button 340, template authoring tool 201 extracts a template from the output presentation. In the example of FIGS. 3A-3C, template authoring tool 201 then switches to template view 303, shown in FIG. 3C, upon completing extraction of the template.

At operational block 525, the exemplary template author publishes the template so that authorized users may access the template. For instance, the author may push the template onto web server 120 of FIG. 1, where it can be accessed by authorized users, for example at client computer 140. Alternatively, the author may save the template locally for local use.

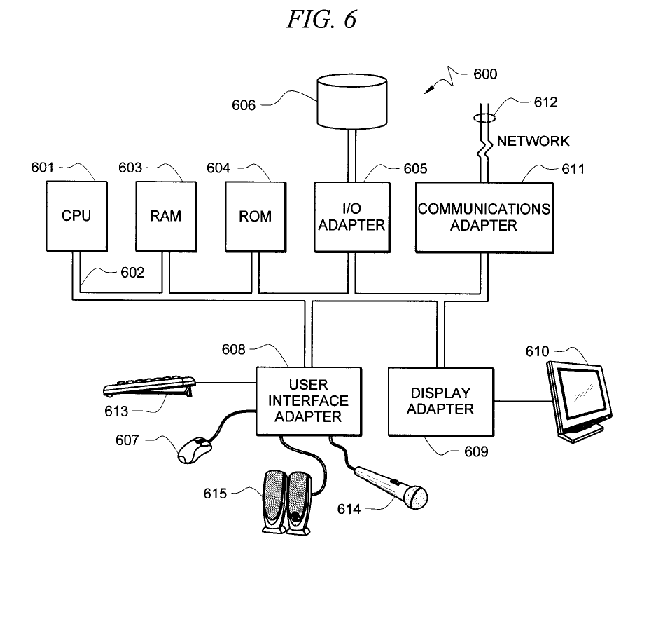

FIG. 6 illustrates an exemplary computer system 600 on which software code template authoring tool 201 may be implemented according to one embodiment of the present invention. Thus, computer system 600 may be deployed to implement a user computer 105 on which template authoring tool 201 resides/executes, a client computer on which authoring 201 also resides/executes, supporting the above-described web template editing operations. Central processing unit (CPU) 601 is coupled to system bus 602. CPU 601 may be any general-purpose CPU. The present invention is not restricted by the architecture of CPU 601 (or other components of exemplary system 600) as long as CPU 601 (and other components of system 600) supports the inventive operations as described herein. CPU 601 may execute the various logical instructions according to embodiments of the present invention. For example, CPU 601 may execute machine-level instructions according to the exemplary operational flows described above in conjunction with FIGS. 4 and 5.

Computer system 600 also preferably includes random access memory (RAM) 603, which may be SRAM, DRAM, SDRAM, or the like. Computer system 600 preferably includes read-only memory (ROM) 604, which may be PROM, EPROM, EEPROM, or the like. RAM 603 and ROM 604 hold user and system data and programs, as is well known in the art.

Computer system 600 also preferably includes input/output (I/O) adapter 605, communications adapter 611, user interface adapter 608, and display adapter 609. I/O adapter 605, user interface adapter 608, and/or communications adapter 611 may, in certain embodiments, enable a user to interact with computer system 600 in order to input information, such as interacting with a user interface of template authoring tool 201.

I/O adapter 605 preferably connects to storage device(s) 606, such as one or more of hard drive, compact disc (CD) drive, floppy disk drive, tape drive, etc., to computer system 600. The storage devices may be utilized when RAM 603 is insufficient for the memory requirements associated with storing data for operations of the template authoring tool 201. Communications adapter 611 is preferably adapted to couple computer system 600 to network 612, which may enable information to be input to and/or output from system 600 via network 612 (e.g., the Internet or other wide-area network, a local-area network, a public or private switched telephony network, a wireless network, or any combination of the foregoing). User interface adapter 608 couples user input devices, such as keyboard 613, pointing device 607, microphone 614, and/or output devices, such as speaker(s) 615 to computer system 600. Display adapter 609 is driven by CPU 601 to control the display on display device 610 to, for example, display information pertaining to an application under development, such as design view 102 of template authoring tool 201, according to certain embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method comprising:
receiving, at a template authoring tool on a computer system, selection of at least a portion of an existing output presentation to be included in a web page template;
receiving, at the template authoring tool, designation of at least one region of the web page template as being editable, wherein text within the at least one region is designated as editable and text format of the text within the at least one region is designated as not editable, the text format comprising a color, a font, or a size of the text in the at least one region designated as not editable; and
generating, via the template authoring tool, the web page template, wherein the web page template is configured for a web page authoring tool to create electronic content according to the web page template, wherein the web page authoring tool allows editing of the at least one editable region and restricts editing of the text format of the text in the at least one editable region in creation of a web page according to the web page template.

2. The method of claim 1 wherein generating the web page template includes deriving a web page template source code from the selected at least a portion of the existing output presentation.

3. The method of claim 2 wherein generating a web page template further includes identifying elements in the web page template source code that correspond to the received designation of at least one region of the existing output presentation.

4. The method of claim 3 wherein the specified at least one editable region within the web page template corresponds to the identified elements in the web page template source code.

5. The method of claim 3 wherein generating further includes removing content elements from the identified elements in the web page template source code.

6. The method of claim 3 wherein identifying elements in the web page template source code further includes inserting markers that define editable regions of the web page template into the web page template source code.

7. The method of claim 1 further comprising publishing the web page template, wherein publishing includes making the web page template available for creating web pages.

8. The method of claim 1 wherein the existing output presentation is a web page.

9. (canceled)

10. A non-transitory computer-readable medium on which is encoded program code comprising:
program code for presenting, at a template authoring tool, a user interface for receiving selection of at least a portion of an existing output presentation to be included in a web page template;
program code for presenting, at the template authoring tool, a user interface for receiving designation of at least one region of the selected portion of the web page template as being editable, wherein text within the at least one region is designated as editable and text format of the text within the at least one region is designated as not editable, the text format comprising a color, a font, or a size of the text in the at least one region designated as not editable; and
program code for generating, via the template authoring tool, the web page template, wherein the web page template is configured for a web page authoring tool to create electronic content according to the web page template, wherein the web page authoring tool allows editing of the designated at least one editable region and restricts editing of the text format of the text in the at least one editable region in creation of a web page according to the web page template.

11. The non-tansitory computer-readable medium of claim 10 wherein generating the web page template includes deriving a web page template source code from the selected at least a portion of the existing output presentation.

12. The non-tansitory computer-readable medium of claim 11 wherein generating a web page template further includes identifying elements in the web page template source code that correspond to the received designation of at least one region of the existing output presentation.

13. The non-tansitory computer-readable medium of claim 12 wherein generating further includes removing content elements from the identified elements in the web page template source code.

14. The non-tansitory computer-readable medium of claim 10 further causing the computer to perform receiving, by the template authoring tool, designation of formatting for the designated at least one editable region.

15. The non-tansitory computer-readable medium of claim 14 wherein generating includes deriving a web page template source code from the selected at least a portion of the existing output presentation; identifying elements in the web page template source code that correspond to the received designation of at least one region of the existing output presentation; and modifying any formatting elements identified in the web page template source code that correspond to the received designation, wherein the modifying includes inserting the received designation of formatting.

16. A system comprising:
a non-transitory computer-readable medium to which instructions are stored;
a web page template extractor operable to
a) receive, at the template extractor, input selecting at least a portion of an existing output presentation to be included in a web page template,
b) receive, at the template extractor, input designating at least one region of the web page template as being editable, wherein text within the at least one region is designated as editable and text format of the text within the at least one region is designated as not editable, the text format comprising a color, a font, or a size of the text in the at least one region designated as not editable; and
d) generate, via the template extractor, a web page template, wherein the web page template is configured for a web page authoring tool to create electronic content according to the web page template, wherein the web page authoring tool allows editing of the designated at least one editable region and restricts editing of the text format of the text in the at least one editable region in creation of a web page according to the web page template.

17. The system of claim 16 wherein generating the web page template includes deriving a web page template source code from the selected at least a portion of the existing output presentation.

18. The system of claim 17 wherein generating a web page template further includes identifying elements in the web page template source code that correspond to the received designation of at least one region of the existing output presentation.

19. The system of claim 18 wherein the specified at least one editable region within the web page template output presentation corresponds to the identified elements in the web page template source.

20. The system of claim 18 wherein generating further includes removing content elements from the identified elements in the web page template source code.

21. The system of claim 18 wherein identifying elements in the web page template source code further includes inserting markers that define editable regions of the web page template output presentation into the web page template source code.

22. The system of claim 16 wherein the template extractor is further operable to receive input designating formatting for the selected at least one editable region.

23. The system of claim 22 wherein generating includes deriving a web page template source code from the selected at least a portion of the existing output presentation; identifying elements in the web page template source code that correspond to the received designation of at least one region of the existing output presentation; and modifying any formatting elements identified in the web page template source code that correspond to the received designation, wherein the modifying includes inserting the received designation of formatting.

24. The system of claim 16 wherein the web page template extractor is incorporated into the web page authoring tool.

25. A method of authoring a web page template from an existing output presentation comprising:
navigating to an existing output presentation, wherein the navigation to the output presentation is facilitated by a template authoring tool;
designating, with a user interface provided by the template authoring tool, regions within the output presentation that will be editable in the web page template, wherein text within the regions is designated as editable and text format is designated as partially editable, the text format comprising a color, a font, or a size of the text in the at least one region designated as partially editable allowing edits to at least one of the color, the font or the size of the text but not allowing edits to all text format; and
extracting a web page template from the output presentation based on the identified regions, wherein the extracting is facilitated by the template authoring tool in response to a command, wherein the web page template is configured for a web page authoring tool to create electronic content according to the web page template, wherein the web page authoring tool allows editing of the designated regions and restricts editing of the text format of the text in the at least one editable region in creation of a web page according to the web page template.

26. The method of claim 1 wherein the web page template identifies at least another region that is not editable to provide a predefined layout for generating multiple web pages using the web page template.

27. The method of claim 26 wherein the web page authoring tool does not allow editing of the at least another region that is not editable in the creation of the web page according to the template.

28. The method of claim 1 wherein the web page template identifies a format of at least another region that is not editable to provide a predefined layout for generating multiple web pages using the web page template.

29. The method of claim 28 wherein the web page authoring tool does not allow editing of the format of the at least another region in the creation of the web page according to the template, wherein edits to content in the at least another region must conform to the format.

30. The method of claim 1 further comprising automatically using, via the template authoring tool, the selection of the at least a portion of an existing output presentation to be included in a web page template to include corresponding portions in the web page template.

31. The method of claim 1 wherein the template authoring tool is the web page authoring tool.
